(19) United States
(12) Patent Application Publication
(10) Pub. No.: US 2025/0247689 A1
(43) Pub. Date: Jul. 31, 2025

(54) SYSTEM AND METHOD FOR WIRELESS COMMUNICATIONS IN DIFFERENT CAPABILITY STATES

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/981,241

(22) Filed: Dec. 13, 2024

Related U.S. Application Data
(60) Provisional application No. 63/668,748, filed on Jul. 8, 2024.
(60) Provisional application No. 63/626,767, filed on Jan. 30, 2024.

(51) Int. Cl. H04W 8/22; H04W 74/0816; H04W 76/20

(52) U.S. Cl. CPC H04W 8/22; H04W 74/0816; H04W 76/20

(57) ABSTRACT

Embodiments of a method and apparatus for wireless communications are disclosed. In an embodiment, a wireless device includes a controller configured to generate an announcement regarding whether the wireless device is capable of initiating a peer device's switch from a low-capability state of a low-capability mode to a high-capability state of the low-capability mode and a wireless transceiver configured to transmit the announcement to a second wireless device.

### CROSS-REFERENCE TO RELATED APPLICATIONS

This application is entitled to the benefit of U.S. Provisional Patent Application Ser. No. 63/626,767, filed on Jan. 30, 2024, and U.S. Provisional Patent Application Ser. No. 63/668,748, filed on Jul. 8, 2024, the contents of which are incorporated by reference herein.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. Wireless devices may operate in different capability states with different capabilities. However, switching between different capability states either causes disruptions in wireless communications or affects wireless communications throughput.

### SUMMARY

Embodiments of a method and apparatus for wireless communications are disclosed. In an embodiment, a wireless device includes a controller configured to generate an announcement regarding whether the wireless device is capable of initiating a peer device's switch from a low-capability state of a low-capability mode to a high-capability state of the low-capability mode and a wireless transceiver configured to transmit the announcement to a second wireless device. Other embodiments are also disclosed.

In an embodiment, the controller is further configured to generate a frame that includes the announcement, and the wireless transceiver is further configured to transmit the frame to the second wireless device.

In an embodiment, the announcement is contained in an Ultra High Reliability (UHR) capabilities element of the frame.

In an embodiment, the wireless device includes a wireless access point (AP), and the second wireless device includes a wireless non-AP station (STA) associated with the wireless AP.

In an embodiment, in response to the announcement, the wireless non-AP STA associated with the wireless AP enables the low-capability mode.

In an embodiment, when the wireless AP only allows STAs that supports the initiating of the peer device's switch from the low-capability state to the high-capability state to associate with the wireless AP, the wireless AP enables the low-capability mode.

In an embodiment, the controller is further configured to generate a beacon frame that includes the announcement, and the wireless transceiver is further configured to transmit the beacon frame to the second wireless device.

In an embodiment, the second wireless device switches from the high-capability state to the low-capability state if a condition related to an Enhanced Multi-Link-Single-Radio (EMLSR)/Enhanced Multi-Link-Multi-Radio (EMLMR) STA's switching to a listening mode is satisfied.

In an embodiment, the wireless device is a transmit opportunity (TXOP) holder, and the second wireless device is a TXOP responder.

In an embodiment, the wireless device includes a wireless non-AP station (STA), and the wireless non-AP STA enables or disables the low-capability mode by exchanging a low-capability mode negotiation request or response frame.

In an embodiment, the wireless device is compatible with an Institute of Electrical and Electronics Engineers (IEEE) 802.11 protocol.

In an embodiment, the wireless device includes a first wireless multi-link device (MLD), the second wireless device includes a second wireless MLD, and the first wireless MLD are linked to the second wireless MLD through wireless links.

In an embodiment, when the first wireless MLD announces enabling or disabling of the low-capability mode of a first wireless link of the wireless links between the first and second wireless MLDs, a Basic Service Set (BSS) Parameters Change Count (BPCC) of the first wireless link is increased by one.

In an embodiment, one of a critical update flag and a nontransmitted basic service set identifier (BSSID) critical update flag related to the first wireless MLD is set to one until a Target Beacon Transmission Time (TBTT) of the first wireless link (e.g., when a mode switch happens) arrives.

In an embodiment, the first wireless link's newly defined element for the enabling or disabling of the low-capability mode is not announced in a beacon of a second wireless link of the wireless links between the first and second wireless MLDs.

In an embodiment, the first wireless link's newly defined element for the enabling or disabling of the low-capability mode is transmitted in a second wireless link of the wireless links between the first and second wireless MLDs, a number of beacon intervals (BIs) related to the TBTT is defined based on the first wireless link's TBTT and beacon interval.

In an embodiment, the peer device consumes less power in the low-capability state than in the high-capability state.

In an embodiment, the low-capability state includes a medium listening state, and the high-capability state includes a frame exchange state.

In an embodiment, a wireless access point (AP) compatible with an Institute of Electrical and Electronics Engineers (IEEE) 802.11 protocol includes a controller configured to generate a group-addressed frame that includes an announcement regarding whether the wireless AP is capable of initiating a peer device's switch from a low-capability state of a low-capability mode to a high-capability state of the low-capability mode, and a wireless transceiver configured to transmit the group-addressed frame to a wireless non-AP station (STA) associated with the wireless AP.

In an embodiment, a method for wireless communication includes at a first wireless device, generating an announcement regarding whether the wireless device is capable of initiating a peer device's switch from a low-capability state of a low-capability mode to a high-capability state of the low-capability mode, and from the first wireless device, transmitting the announcement to a second wireless device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts messages for operating a STA in a low-capability mode.

FIG. 5 depicts messages for operating an AP in a low-capability mode.

FIG. 6 depicts a state diagram that includes an low-capability mode being enabled and a low-capability mode being disabled in accordance with an embodiment of the invention.

FIG. 7 illustrates a frame format in accordance with an embodiment of the invention.

FIG. 8 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

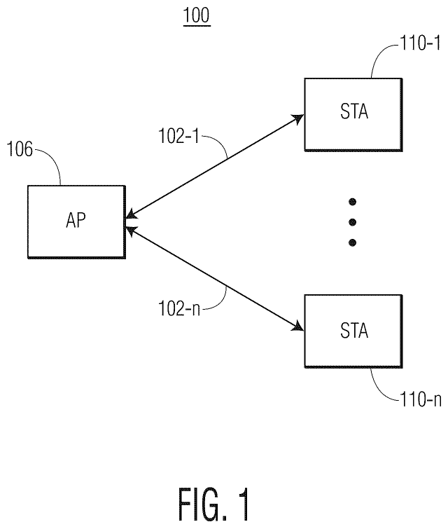

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n with n being an integer may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

Wireless devices may operate in different capability states with different capabilities. For example, in a low-capability state, a wireless device may detect medium busy/idle and/or receive initial control frame and broadcast frames, and in a high-capability state, the wireless device may execute frame exchanges with high capabilities (high MAC, >1 Service Set (SS), and/or wider bandwidth (BW)). A wireless device can switch between a low-capability state and a high-capability state. For example, a wireless device can switch between a low-capability state of a low-capability mode and a high-capability state of the low-capability mode.

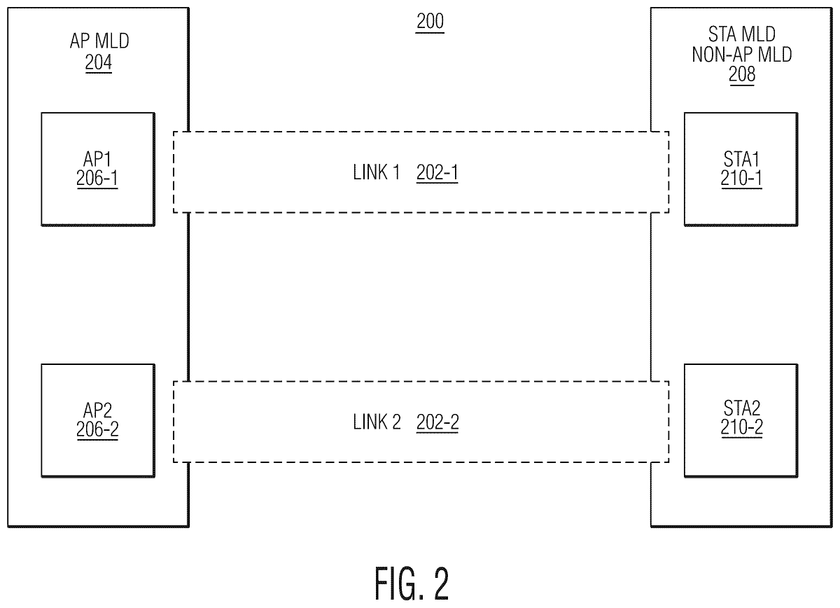

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD and multiple STA MLDs, or multiple AP MLDs and more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames other than Beacon, Data frames, control frames etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a Traffic Identifier (TID)-to-link mapping negotiation frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

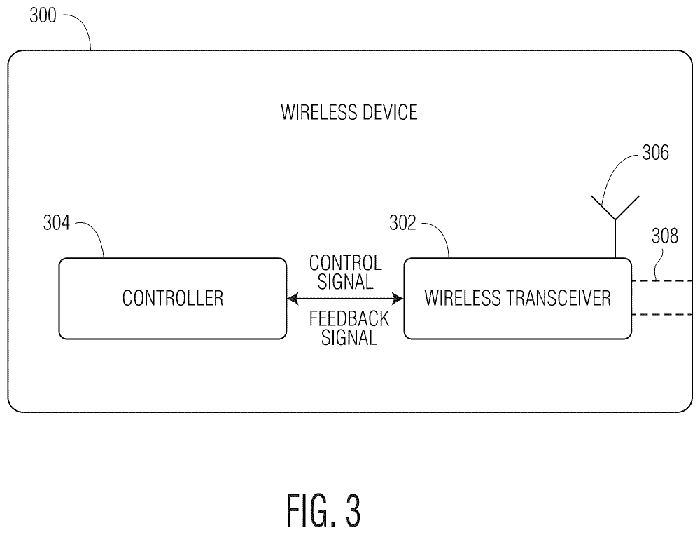

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

The wireless device 300 may operate in different capability states with different capabilities. For example, a low-capability state includes a medium listening state that detects medium busy/idle, receives initial control frame and broadcast frames, and a high-capability state includes a frame exchange state that executes frame exchanges with high capabilities (high MAC, >1 Service Set (SS), and/or wider bandwidth (BW)).

In accordance with an embodiment of the invention, the controller 304 is configured to generate an announcement regarding whether the wireless device is capable of initiating a peer device's switch from a low-capability state of a low-capability mode to a high-capability state of the low-capability mode, and the wireless transceiver 302 is configured to transmit the announcement to a second wireless device, for example, through the at least one antenna 306. In some embodiments, the controller 304 is further configured to generate a frame that includes the announcement, and the wireless transceiver 302 is further configured to transmit the frame to the second wireless device. In some embodiments, the announcement is contained in an Ultra High Reliability (UHR) capabilities element of the frame. In some embodiments, the wireless device includes a wireless access point (AP), and the second wireless device includes a wireless non-AP station (STA) associated with the wireless AP. In some embodiments, in response to the announcement regarding the capability of initiating a peer device's switch from the low-capability state to the high-capability state from an AP, the wireless non-AP STA associated with the wireless AP can enable the low-capability mode. In some embodiments, when the wireless AP only allows STAs that support the initiating of the peer device's switch from the low-capability state to the high-capability state to associate with the wireless AP, the wireless AP enables the low-capability mode. In some embodiments, when the wireless AP without multiple BSSID support (i.e., not in a multiple BSSID AP set) only allows STAs that have the capability of initiating the peer device's switch from the low-capability state to the high-capability state to associate with the wireless AP (i.e., all associated STAs support the initiating of the peer device's switch from the low-capability state to the high-capability state to associate with the wireless AP), the wireless AP can enable the low-capability mode. In some embodiments, when all the APs in a multiple BSSID AP set only allows STAs that have the capability of initiating the peer device's switch from the low-capability state to the high-capability state to associate with the wireless AP (i.e. all the STAs associated with all the multiple BSSID set APs support the initiating of the peer device's switch from the low-capability state to the high-capability state to associate with the wireless AP), the multiple BSSID set APs can enable the low-capability mode. In some embodiments, the controller 304 is further configured to generate a beacon frame that includes the announcement of enabling the low-capability mode or disabling the low-capability mode, and the wireless transceiver 302 is further configured to transmit the beacon frame to the second wireless device. In some embodiments, the controller 304 is further configured to generate the Beacons and Probe Response that includes the announcement of a future time when to enable low-capability mode or disable the low-capability mode, and the wireless transceiver 302 is further configured to transmit the Beacons and Probe Response to the second wireless device. In some embodiments, the future time is the future target TBTT of the AP enabling its low-capability mode. In some embodiment, one AP announces the remaining beacon intervals (BIs) to the target TBTT. In some embodiment, one AP announces the remaining beacon intervals (BIs) to be 0 in the Beacon being scheduled to transmit at the target TBTT. In some embodiments, the second wireless device switches from the high-capability state to the low-capability state if a condition related to an Enhanced Multi-Link-Single-Radio (EMLSR)/Enhanced Multi-Link-Multi-Radio (EMLMR) STA's switching from frame exchanges in one eMLSR/eMLMR link to listening on multiple eMLSR/eMLMR links is satisfied. In some embodiments, the wireless device 300 is a transmit opportunity (TXOP) holder, and the second wireless device is a TXOP responder. In some embodiments, the wireless device 300 includes a wireless non-AP station (STA), and the wireless non-AP STA enables or disables the low-capability mode by exchanging a low-capability mode negotiation request or response frame. In some embodiments, the wireless device 300 is compatible with an Institute of Electrical and Electronics Engineers (IEEE) 802.11 protocol. In some embodiments, the wireless device includes a first wireless multi-link device (MLD), the second wireless device incudes a second wireless MLD, and the first wireless MLD are linked to the second wireless MLD through wireless links. In some embodiments, when the first wireless MLD announces enabling or disabling of the low-capability mode of a first wireless link of the wireless links between the first and second wireless MLDs, a Basic Service Set (BSS) Parameters Change Count (BPCC) of the first wireless link is increased by one. In some embodiments, one of a critical update flag and a nontransmitted basic service set identifier (BSSID) critical update flag related to the first wireless MLD is set to one until a Target Beacon Transmission Time (TBTT) of the first wireless link when a mode switch happens arrives. In some embodiments, the first wireless link's newly defined element for the enabling or disabling of the low-capability mode is not announced in a beacon of a second wireless link of the wireless links between the first and second wireless MLDs. In some embodiments, the first wireless link's newly defined element for the enabling or disabling of the low-capability mode is transmitted in Probe Response frame in a second wireless link of the wireless links between the first and second wireless MLDs, a number of beacon intervals (BIs) related to the TBTT is defined based on the first wireless link's TBTT and beacon interval. In some embodiments, the peer device consumes less power in the low-capability state than in the high-capability state. In some embodiments, the low-capability state in the low-capability mode includes a medium listening state that detects medium busy/idle, receives initial control frame and broadcast frames, and the high-capability state in low-capability mode includes a frame exchange state that executes frame exchanges with high capabilities (high MAC, >1 Service Set (SS), and/or wider bandwidth (BW)). In some embodiments, the low-capability state in the low-capability mode includes a state that detects medium busy/idle, receives broadcast frames and does frame exchanges in 20 MHz, 1SS, and restricted data date; and the high-capability state in the low-capability mode includes a frame exchange mode that executes frame exchanges with the high-capability state (high MAC, >1 SS, and/or wider BW).

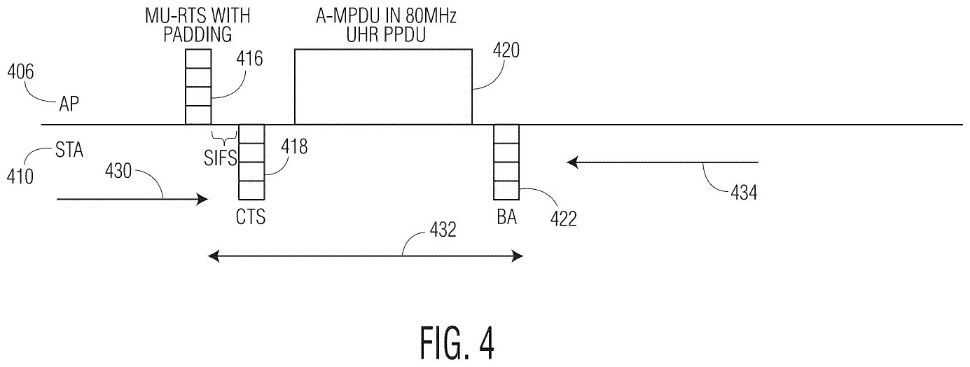

FIG. 4 depicts messages for operating a STA 410 in a low-capability mode. A horizontal timeline proceeds from left to right with transmission from the STA 410 below the timeline and transmissions from an AP 406 above the timeline. The vertical extent of each transmission indicates the number of channels being used, e.g., 20 MHz channels. This example pertains to UHR (Ultra High Reliability) in which there is an MU-RTS (Multi-User Request to Send), then a CTS (Clear to Send) in response, then a wake and a wide bandwidth (BW) A-MPDU (Aggregated MAC Protocol Data Unit). A successful A-MPDU is answered with a BA (Block Acknowledgement). In some embodiments, the BSRP Trigger and QoS Null or the BSRP Trigger and Multi-STA BA are used instead of MU-RTS and CTS.

The sequence of FIG. 4 begins with an MU-RTS 416 transmitted by the AP 406 to multiple users, including the STA 410. In this example, the MU-RTS 416 is carried in a non-HT duplicate PPDU by using four 20 MHz channels indicated by the four blocks. The AP may accommodate the STAs to allow the STAs to switch from low-capability state to high-capability state by using padding in the initial MU-RTS 416 that initiates the frame exchange. The padding may follow the padding procedure defined by 802.11ax after User Info fields addressed to the STAs (User Info fields with Association Identifier (AID) values in the AID12 fields equal to the AIDs of the addressed STAs) in the initial MU-RTS 416. The STA 410 is in a low-capability state until the end of the PPDU carrying MU-RTS (indicated by the duration 430) and after the end of the PPDU carrying MU-RTS the STA 410 switches to high-capability state.

In some embodiments, the STA 410 listens in a primary channel (one of the 20 MHz channels) in a low-capability state. After receiving the MU-RTS, the STA 410 tries to switch to a high-capability state and finishes the switch no later than the end of the PPDU carrying the MU-RTS with padding 413. The MU-RTS 416 is answered with a CTS 418 in high-capability whose BW is defined in MU-RTS (the maximal BW of the responding CTS is the same as the soliciting MU-RTS, in this example 80 MHz) from the STA 410 to the AP 406. In this example, for a low-capability mode, the STA 410 is listening in the low-capability mode for a start duration 430 that ends right after the reception of the MU-RTS 416. The STA 410 then enters a high-capability state for a transmit/receive duration 432 with high Modulation Coding Scheme (MCS), >1SS, and/or wider BW until after sending the BA 422. After the BA 422, the AP returns to a low-capability state for an end duration 434 which ends upon receiving the next MU-RTS or other message.

With static BW negotiation, the STA 410 responds to the MU-RTS 416 with the CTS 418 in a BW that is the same as the PPDU carrying MU-RTS 416. If an MU-RTS is carried in a PPDU of the 80 MHz, the CTS 418 can be transmitted in a 80 MHz PPDU if the TXOP responder detects the idle medium in 80 MHz (virtual carrier sensing detects 0 in basic network allocation vector (NAV) timer and within a Short Interframe Space (SIFS) between the MU-RTS and the CTS, the PHY carrier sensing indicates 80 MHz channel idle).

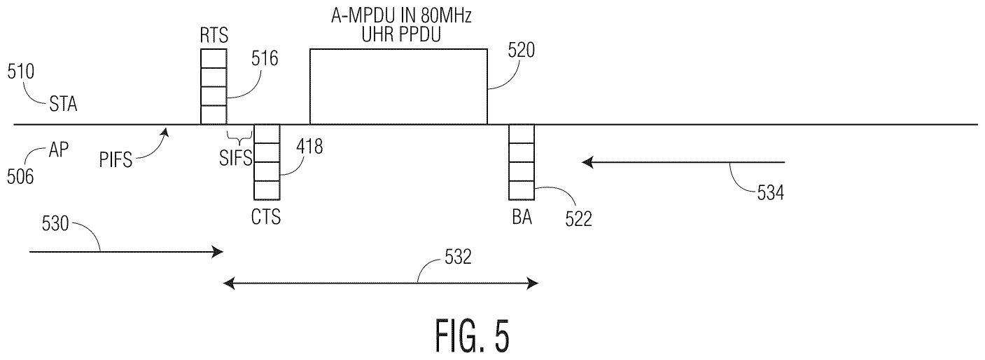

FIG. 5 depicts messages for operating an AP 506 in a low-capability mode. A horizontal timeline proceeding from left to right with transmission from a STA 510 above the timeline and transmissions from the AP 506 below the timeline. The vertical extent of each transmission indicates the number of channels being used, e.g., 20 MHz channels. This example pertains to UHR (Ultra High Reliability) in which there is an RTS 516 (Request to Send) with a switching from low-capability state to high-capability state during the reception of RTS, then a CTS 518 (Clear to Send) in response, and a wide BW A-MPDU 520 (Aggregated MAC Protocol Data Unit). A successful A-MPDU 520 is answered with a BA 522 (Block Acknowledgement). In some embodiments, RTS and CTS can be used when the TXOP responder (AP 506 in the figure) has 0 padding requirement for the switch from the low-capability state to the high-capability state.

The sequence of FIG. 5 begins with an RTS 516 transmitted by the STA 510 to the AP 506. In this example, the RTS 516 is in a non-HT duplicate PPDU with four 20 MHz channels indicated by the four blocks. The AP 506 is listening in primary channel (one of the 20 MHz channels) in low-capability state. During the reception and processing of the RTS, the AP switches from low-capability state to high capability state and such switching is done no later than the end of the PPDU carrying RTS 516. The RTS 516 is answered with a CTS 518 from the AP 506 in high-capability state to the STA 510. In this example, for a low-capability mode, the AP is listening in the low-capability state for a start duration 530 that ends at the end of PPDU carrying the RTS 516. The AP 506 then enters a high-capability state for a transmit/receive duration 532 to conduct the frame exchanges by using higher MCS, wider BW, or >1SS until after sending the BA 552. After the BA, the AP returns to a low-capability state for an end duration 534 which ends upon receiving the next RTS or other message.

With static BW negotiation, the AP 506 responds to the RTS 516 with the CTS 508 in an 80 MHz BW that is the same as the BW of the RTS 516. If RTS is carried in a PPDU with the 80 MHz BW, the CTS 508 can be transmitted in 80 MHz PPDU if the TXOP responder detects the idle medium in 80 MHz (virtual carrier sensing detects 0 in basic NAV timer and within SIFS between MU-RTS and CTS, the PHY carrier sensing indicates 80 MHz channel idle). In other circumstances no clear channel assessment (CCA) is required, e.g., if the soliciting frame 516 is a BSRP (Buffer Status Report Poll) Trigger to solicit a QoS (Quality of Service) Null or Multi-STA BA.

In another example, with dynamic BW negotiation, the AP 506 responds to the RTS 516 with a CTS 518 in the widest idle channel but no wider than the BW of the PPDU carrying RTS 516. This may be a primary 20 MHz channel, a primary 40 MHz channel, or a primary 80 MHz channel. The CTS is sent after performing a PHY CCA (Clear Channel Assessment not shown) within a SIFS between RTS 516 and CTS 518 and virtual carrier sensing. Upon detecting the RTS 516 in a 20 MHz channel, the TXOP holder, i.e., the AP, can do a CCA with a wide BW within the time of a SIFS after the RTS 516 before transmitting the CTS 518.

A STA/AP may be in low-capability state of low-capability mode where a peer device needs to transmit an initial control frame (e.g., a MU-RTS frame, a BSRP Trigger frame, or a RTS frame) to soliciting the STA/AP's high-capability state for the frame exchanges other than the control frame exchange. A STA/AP in low-capability state may be able to receive a frame (Data frame, management frame) other than initial control frame without the initial control frame exchange. For such STA/AP in the low-capability state, the peer device may transmit the short data and management frame to the STA/AP in the low-capability state without first transmitting initial control frame in non-HT (duplicate) PPDU. A mobile AP or a STA may announce whether it needs the initial control frame exchange to receive frames other than the initial control frame in 20 MHz PPDU, e.g. for data frame transmission/reception, the probing, association, key negotiation. In some embodiments, the behaviours of the mobile AP can be applied to the regular AP.

Some implementations of low-capability listening mode capability announcement, for example, by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5 are described as follows.

In some embodiments, a non-AP STA (referred to as a STA) or an AP announces whether it can support the initiation of a peer device's switch from low-capability state to high-capability state in its UHR Capabilities element.

In some embodiments, when an AP announces that it is capable of initiating the peer device's switch from low-capability state to high-capability state, an associated STA supporting low-capability mode can enable its low-capability mode.

In some embodiments, when an AP only allows the STAs that support the initiating of the peer device's switch from a low-capability state in a low-capability mode to a high-capability state of low-capability mode to associate with it, the AP can enable its low-capability mode. In some embodiments, when the wireless AP without multiple BSSID support (i.e. not in a multiple BSSID AP set) only allows STAs that have the capability of initiating the peer device's switch from the low-capability state of the low-capability mode to the high-capability state of low-capability mode to associate with the wireless AP, the wireless AP can enable the low-capability mode. In some embodiments, when all the APs in a multiple BSSID AP set only allows STAs that have the capability of initiating the peer device's switch from the low-capability state of the low-capability mode to the high-capability state of the low-capability mode to associate with the wireless AP, the multiple BSSID set APs can enable the low-capability mode.

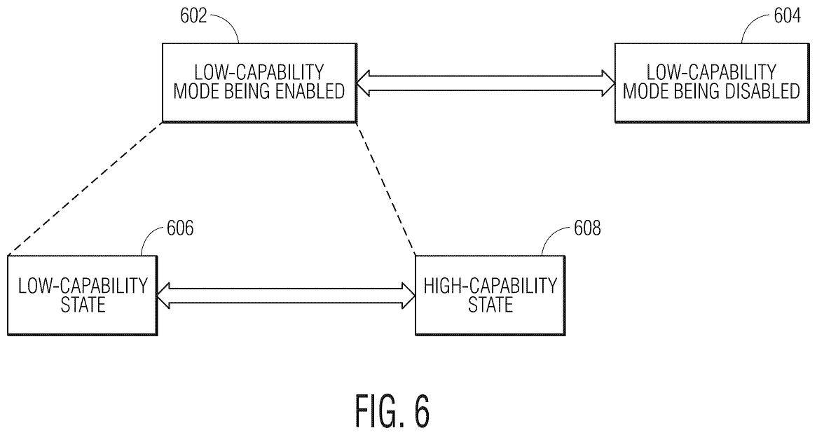

FIG. 6 depicts a state diagram that includes an low-capability mode being enabled 602 and a low-capability mode being disabled 604 in accordance with an embodiment of the invention. In the embodiment depicted in FIG. 6, a wireless device, which may be an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the wireless device 300 depicted in FIG. 3, the AP 406 and/or the STA 410 depicted in FIG. 4, and/or the AP 506 and/or the STA 510 depicted in FIG. 5, can switch between operating in the low-capability mode being enabled 602 and operating in the low-capability mode being disabled 604. In some embodiments, a wireless device consumes less power in the low-capability mode than in the low-capability mode being disabled. In some embodiments, the low-capability mode includes a low-capability state 606 and a high-capability state 608. In some embodiments, a wireless device consumes less power in the low-capability state than in the high-capability state.

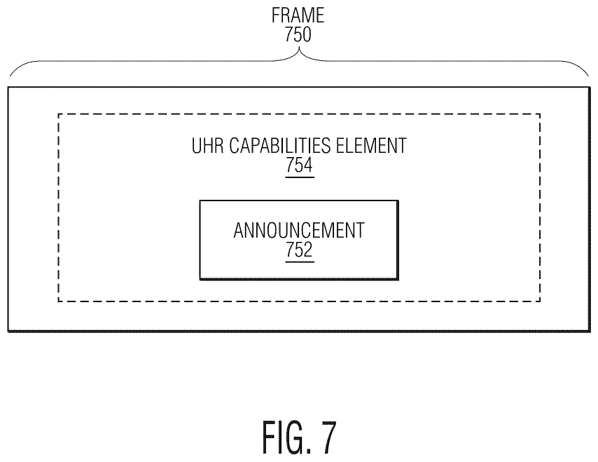

FIG. 7 illustrates a frame format 750 in accordance with an embodiment of the invention. The frame format 750 illustrated in FIG. 7 may be used by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5. In the embodiment depicted in FIG. 7, the frame format 750 includes an announcement 752 regarding whether a wireless device can enable or disable a peer device's low-capability mode. In some embodiments, the announcement 752 is contained in an Ultra High Reliability (UHR) capabilities element 754 of the frame 750. In some embodiments, the announcement 752 is contained in an Low-Capability Mode capabilities element (not shown in the figure).

Some implementations of frame type being received in a low-capability state of the low-capability mode, for example, by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5 are described as follows.

In some embodiments, if/when at least one STA associated with an AP is in a low-capability state of low-capability mode and cannot receive a frame other than the initial control frame, the AP needs to transmit a group-addressed frame after a Delivery Traffic Indication Map (DTIM) Beacon. In some embodiments, if/when all STAs associated with an AP that are in a low-capability state of the low-capability mode can receive any frame but cannot transmit responding frame in the low-capability mode, the AP can transmit a group-addressed frame without satisfying the requirement of after a Delivery Traffic Indication Map (DTIM) Beacon. In some embodiments, a STA/AP capable of enabling the low-capability mode can indicate its capabilities which types of frames it can receive in a low-capability state of the low-capability mode, which types of PPDU it can receive in low-capability state of the low-capability mode, and whether it can transmit responding frame in the low-capability state of the low-capability mode.

Some implementations of switching back to a low-capability state, for example, by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5 are described as follows.

In some embodiments, when a STA/AP as the TXOP responder is in a high-capability state and conducts the frame exchanges with its peer device (associated AP/STA respectively) in a TXOP, the STA/AP switch back to a low-capability state as follows:

### Option 1:

The STA/AP as the TXOP responder switches back to the low-capability state of low-capability mode if the condition related to an Enhanced Multi-Link-Single-Radio (EMLSR)/Enhanced Multi-Link-Multi-Radio (EMLMR) STA's switching back to the low-capability state on eMLSR/eMLMR link(s) happens/satisfies.

### Option 2:

The STA/AP as the TXOP responder switches back to the low-capability state at the end of the TXOP.

### Option 3:

The STA as the TXOP responder switches back to the low-capability state if the condition related to EMLSR/EMLMR STA's switching back to the eMLSR link listening on eMLSR/eMLMR link(s) happens. The AP as the TXOP responder switches back to the low-capability state at the end of the TXOP.

Some implementations of low-capability mode enabling/disabling, for example, by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5 are described as follows.

In some embodiments, a mobile AP (or a regular AP) announces whether its low-capability mode is enabled or disabled in an UHR Operation element or a new element. In some embodiments, a mobile AP (or a regular AP) announces its future Target Beacon Transmission Time (TBTT) when the AP will enable its low-capability mode or disable its low-capability mode as indicated in the related field of the Beacon (in a new defined element). In some embodiments, the future TBTT is defined by the number of Beacon Intervals (BIs) indicated in the related field of the transmitted Beacon (in a new defined element or the UHR Operation element). In some embodiments, after each TBTT, the number of BIs indicated in the related field of the transmitted Beacon is decreased by 1. In some embodiments, when the number of BIs indicated in the related field of the transmitted Beacon becomes 0, the AP enable/disable its low-capability mode as announced. In some embodiments, the new defined element (or the UHR Operation element) also includes the padding delay for the switch from a low-capability state to a high-capability state, and the transition delay from the high-capability state to the low-capability state.

In some embodiments, a STA enables/disables its low-capability mode by exchanging low-capability mode negotiation request/response frame.

Some implementations of low-capability mode enabling/disabling under Multi-Link Operation (MLO), for example, by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5 are described as follows.

In some embodiments, the enabling and disabling of the low-capability mode in a link of an AP MLD is a critical event.

In some embodiments, when the AP MLD announces the link1's low-capability mode enabling/disabling through a newly defined element or an UHR Operation element, the BSS Parameters Change Count (BPCC) of the related link is increased by 1. In some embodiments, one of the Critical Update Flag and the Nontransmitted basic service set identifier (BSSID) Critical Update Flag related to the AP MLD is set to 1 until the TBTT of link1 when the mode switch happens arrives. In some embodiments, the link1's newly defined element (or UHR Operation element) for the low-capability mode enabling/disabling is not announced in another link's Beacon. In some embodiments, in another variant, the link1's new defined element (or UHR Operation element) for the low-capability mode enabling/disabling is also announced in another link's Beacon and Multi-Link (ML) Probe Response frame.

In some embodiments, when the newly defined element about the enabling/disabling of the low-capability mode (capability mode switch) of link1 is transmitted in another link, the number of BIs related to the target TBTT is defined based on link1's TBTT, beacon interval.

In some embodiments, when a STA affiliated with a non-AP MLD in link1 enables/disables its low-capability mode by exchanging at least one low-capability mode negotiation request/response frame, the Negotiation Request/Response frame can be transmitted in another link.

In some embodiments, a method of conducting frame exchanges for Data/Management frame between a first device and a second device includes announcing, by both the first device and second device respectively, whether it supports a low-capability mode where when in the low-capability mode the device can be in a low-capability state for medium listening and restricted frame exchange in 20 MHz, low data rate, and/or 1SS, and in a high-capability state for data/management frame exchanges in >=20 MHz, high MCS, and/or >=1SS, announcing, by both the first device and second device respectively, whether it is capable of initiating the peer device's switch from the low-capability state in the low-capability mode to high-capability state in low-capability mode, notifying, by both the first device and second device respectively, its enabling/disabling of low-capability mode if its peer device announces the support of initiating the device's switch from the low-capability state to the high-capability state, and after receiving, by a device in the low-capability state of the low-capability mode, the initial control frame from its peer device, the device switch to the high-capability state to conduct the frame exchanges until the event switching back to the low-capability state happens. The method may further include the event switching back to the low-capability state happens is the same as the event to trigger a EMLSR STA's switching back to the link listening mode. In this method, the device as a mobile AP may announce its enabling/disabling of the low-capability mode if all the associated STAs announce the support of initiating the AP's switch from the low-capability state in the low-capability mode to the high-capability state in the low-capability mode. In this method, the device as a mobile AP without being one of the multiple BSSID AP set may announce its enabling/disabling of the low-capability mode if all the associated STAs announce the support of initiating the AP's switch from the low-capability state of the low-capability mode to the high-capability state of the low-capability mode. In this method, the device as a mobile AP being one AP of a multiple BSSID AP set may enabling/disabling the low-capability mode if all the associated STAs associated with all APs of the multiple BSSID AP set announce the support of initiating the AP's switch from the low-capability state of the low-capability mode to the high-capability state of the low-capability mode. In this method, the announcement may be carried in multiple Beacons with the indicated specific TBTT (through the remaining BIs for the specific TBTT) when the AP enables its low-capability mode or disable its low-capability mode. In this method, each time a new Beacon is transmitted, the remaining BIs for the specific TBTT may be decreased by 1. In some embodiments, the discussion for a mobile AP is applied to a regular AP.

A mobile AP (soft AP or software implemented AP) may be in a low-capability state of a low-capability mode to monitor the medium where an associated STA sends a MU-RTS (or BSRP Trigger) in non-HT duplicate PPDU as the initial frame of a TXOP to solicit the AP's high-capability state of the low-capability mode. The MU-RTS (or BSRP Trigger) may carry the padding field if the AP requires additional time to change from the low-capability state of the low-capability mode to its high-capability state of the low-capability mode no later than the end of the PPDU carrying the MU-RTS (or BSRP Trigger). After receiving the MU-RTS (BSRP Trigger), the AP can change to the high-capability state to conduct the frame exchanges in >=20 MHz BW, high MCS, >=1SS with the STA until the end of the TXOP. There is some argument that an unassociated STA needs to send the MU-RTS (or BSRP Trigger) also in order to conduct the frame exchange with the AP for the active scanning, association, authentication.

The reason for transmitting MU-RTS (or BSRP Trigger) as the initial frame by an unassociated STA is that a mobile AP in a low-power listening mode may only be able to decode MU-RTS, BSRP Trigger, or may not be able to send the responding frame if the additional padding is not carried in the soliciting frame. However, some mobile AP in a low-capability mode can receive any frame in 20 MHz PPDU and transmit the responding frame without the additional padding in the soliciting frame. A mobile AP that supports the low-capability mode may not be in the low-capability mode. Some mobile AP may not support the low-capability mode. An unassociated STA does not know the padding requirement of a mobile AP. After scanning, an unassociated STA knows exactly the mobile AP's capabilities, whether the mobile AP is in the low-capability mode. The unassociated STA may exactly know whether the initial MU-RTS is needed or not. The design of the MU-RTS for unassociated STA is not clear.

The following are defined in IEEE 802.11ax/11be about MU-RTS
a. A MU-RTS always has broadcast address as RA.
b. The AID12 subfield of a User Info field that is not Special User Info field indicates the recipient of the User Info field.

An unassociated STA cannot send a MU-RTS to an AP per the current MU-RTS content. The receiver address (RA) is a broadcast address, the AID12 in the User Info field of MU-RTS most likely has value 0. It is not clear how to support unicast Probe Request and broadcast Probe.

### MU-RTS Addressed to a Single AP:

In some embodiments, in a MU-RTS addressed to a single AP, the RA of the MU-RTS being addressed to an AP is the AP's BSSID. Such MU-RTS is addressed to the AP with the BSSID equal to MU-RTS's TA.

In some embodiments, AID12 subfield of the User Info field being addressed to the recipient STA is set to 0.

In some embodiments, a mobile AP that receives a MU-RTS with unicast RA equal to its BSSID and AID12 of the User Info field being 0 responds with CTS and switches to the high-capability state no later than the end of the PPDU carrying the MU-RTS.

In some embodiments, the MU-RTS (or BSRP Trigger) addressed to a single AP is used for transmitting unicast Probe Request, management frame for authentication, Association, unicast public Action frame if the addressed AP can only decode MU-RTS (or BSRP Trigger) in low-capability state of low-capability mode.

In some embodiments, if a STA does not know that the destination AP doesn't need MU-RTS (or BSRP Trigger) reception for receiving public action frame and receiving the frame for active probing, association authentication, the STA may transmit a MU-RTS (or BSRP Trigger) to an AP to announce that it will transmit the following frame for active probing, association authentication and transmitting public action frame to the AP SIFS after it receives the responding CTS.

### MU-RTS Addressed to Multiple APs:

In some embodiments, in a MU-RTS addressed to multiple APs, the RA of the MU-RTS being addressed is broadcast address.

In some embodiments, AID12 subfield of the User Info field being addressed to the recipient STA is set to 0.

In some embodiments, a mobile AP that receives a MU-RTS with broadcast RA and AID12 of the User Info field being 0 may respond with CTS. The synchronization requirement of CTS transmission is the same as STA's CTS transmission after receiving MU-RTS.

In some embodiments, before a STA intends to transmit a broadcast Probe Request frame or a broadcast public Action frame, the STA may transmit a MU-RTS with the broadcast address in receiver address (RA) field of the MU-RTS.

Some implementations of activity before and after scanning, for example, by the wireless communications system 100 depicted in FIG. 1, the multi-link (ML) communications system 200 depicted in FIG. 2, the wireless device 300 depicted in FIG. 3, the AP 406 and/or the STA 410 depicted in FIG. 4, and/or the AP 506 and/or the STA 510 depicted in FIG. 5 are described as follows.

In some embodiments, in Beacon, Probe Response and the other management frame, an AP announces whether it requires the MU-RTS+CTS (or BSRP Trigger+QoS Null, BSRP Trigger+Multi-STA BA) frame exchange as the first frame exchange in a TXOP before receiving the other frame in the TXOP when the TXOP is for probing, association, authentication, reception of public Action frame, i.e., whether it can receive frames of any frame types and can send the responding frames without the additional padding in the soliciting frame.

In some embodiments, an unassociated STA may transmit MU-RTS (or BSRP Trigger) with the maximal padding time defined by the specification if the STA doesn't know anything of AP(s) being probed for active probing.

In some embodiments, after the probing with an AP, i.e. after receiving either Beacon of Probe Response frame from the AP, the STA needs to transmit MU-RTS (or BSRP Trigger) before transmit the other frames for association or authentication with the AP if the AP requires the MU-RTS+CTS (or BSRP Trigger+QoS Null, BSRP Trigger+Multi-STA BA) frame exchange as the first frame exchange in a TXOP before receiving the other frame in the TXOP. The AP's announcement about whether it requires the MU-RTS+CTS (or BSRP Trigger+QoS Null, BSRP Trigger+Multi-STA BA) frame exchange as the first frame exchange in a TXOP before receiving the other frame in the TXOP is done in Beacon and Probe Response frame.

In some embodiments, after the probing with an AP, i.e., after receiving either Beacon of Probe Response frame from the AP, the STA does not need to transmit MU-RTS (or BSRP Trigger+QoS Null, BSRP Trigger+Multi-STA BA) before transmit the other frames for association or authentication with the AP if the AP does not require the MU-RTS+CTS (or BSRP Trigger+QoS Null, BSRP Trigger+Multi-STA BA) frame exchange as the first frame exchange in a TXOP before receiving the other frame in the TXOP.

In some embodiments, a method of performing probing, authentication, association and exchanging the public Action frame by a first device with a second device includes transmitting, by the first device to the second device(s), a request to exit from the low-capability state of low-capability mode for the following frame exchange, exiting, by the second device, from the low-capability state of low-capability mode and transmitting the responding frame to the first device after receiving the requesting frame, and transmitting, by the first device, the other frame SIFS after receiving the responding frame. The second device may announce whether it requires the request for it to exit from the low-capability state of low-capability mode for probing, association, authentication and reception of public Action frame. The request can be unicast request or broadcast request carried in MU-RTS or BSRP Trigger. The unicast request may be the MU-RTS (or BSRP Trigger) with the destinated BSSID as the RA of MU-RTS (or BSRP Trigger). The broadcast request may be the MU-RTS with the broadcast address as the RA of MU-RTS. In some embodiments, the first device will not transmit the MU-RTS (or BSRP Trigger) for active probing, association, authentication, transmitting public action if it knows that the addressed second device announces that the addressed second device does not require the request for it to exit from the low-capability state of low-capability mode for probing, association, authentication and reception of public Action frame.

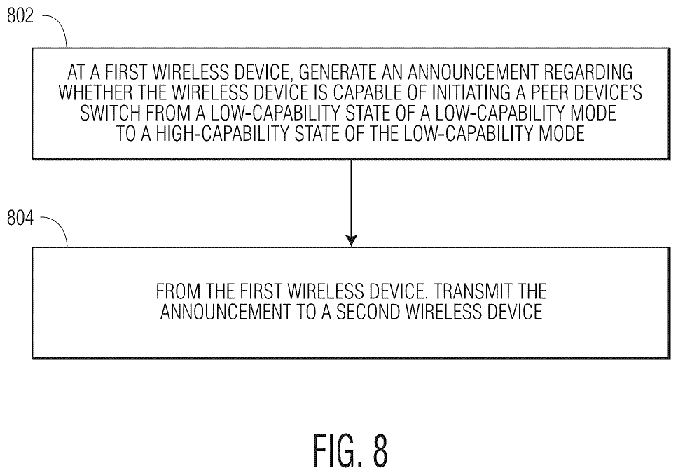

FIG. 8 is a process flow diagram of a method for wireless communications in accordance with an embodiment of the invention. At block 802, at a first wireless device, an announcement regarding whether the wireless device is capable of initiating a peer device's switch from a low-capability state of a low-capability mode to a high-capability state of the low-capability mode is generated. At block 804, from the first wireless device, the announcement is transmitted to a second wireless device. The first wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the wireless device 300 depicted in FIG. 3, the AP 406 and/or the STA 410 depicted in FIG. 4, and/or the AP 506 and/or the STA 510 depicted in FIG. 5. The second wireless device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, the wireless device 300 depicted in FIG. 3, the AP 406 and/or the STA 410 depicted in FIG. 4, and/or the AP 506 and/or the STA 510 depicted in FIG. 5.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate an announcement regarding whether the wireless device is capable of initiating a peer device's switch from a low-capability state of a low-capability mode to a high-capability state of the low-capability mode; and
a wireless transceiver configured to transmit the announcement to a second wireless device.

2. The wireless device of claim 1, wherein the controller is further configured to generate a frame that comprises the announcement, and wherein the wireless transceiver is further configured to transmit the frame to the second wireless device.

3. The wireless device of claim 2, wherein the announcement is contained in an Ultra High Reliability (UHR) capabilities element of the frame.

4. The wireless device of claim 1, wherein the wireless device comprises a wireless access point (AP), and wherein the second wireless device comprises a wireless non-AP station (STA) associated with the wireless AP.

5. The wireless device of claim 4, wherein in response to the announcement, the wireless non-AP STA associated with the wireless AP enables the low-capability mode.

6. The wireless device of claim 4, wherein when the wireless AP only allows STAs that supports the initiating of the peer device's switch from the low-capability state to the high-capability state to associate with the wireless AP, the wireless AP enables the low-capability mode.

7. The wireless device of claim 4, wherein the controller is further configured to generate a beacon frame that comprises the announcement, and wherein the wireless transceiver is further configured to transmit the beacon frame to the second wireless device.

8. The wireless device of claim 1, wherein the second wireless device switches from the high-capability state to the low-capability state if a condition related to an Enhanced Multi-Link-Single-Radio (EMLSR)/Enhanced Multi-Link-Multi-Radio (EMLMR) STA's switching to a listening mode is satisfied.

9. The wireless device of claim 8, wherein the wireless device is a transmit opportunity (TXOP) holder, and wherein the second wireless device is a TXOP responder.

10. The wireless device of claim 1, wherein the wireless device comprises a wireless non-AP station (STA), and wherein the wireless non-AP STA enables or disables the low-capability mode by exchanging a low-capability mode negotiation request or response frame.

11. The wireless device of claim 1, wherein the wireless device is compatible with an Institute of Electrical and Electronics Engineers (IEEE) 802.11 protocol.

12. The wireless device of claim 1, wherein the wireless device comprises a first wireless multi-link device (MLD), wherein the second wireless device comprises a second wireless MLD, and wherein the first wireless MLD are linked to the second wireless MLD through a plurality of wireless links.

13. The wireless device of claim 12, wherein when the first wireless MLD announces enabling or disabling of the low-capability mode of a first wireless link of the wireless links between the first and second wireless MLDs, a Basic Service Set (BSS) Parameters Change Count (BPCC) of the first wireless link is increased by one.

14. The wireless device of claim 13, wherein one of a critical update flag and a nontransmitted basic service set identifier (BSSID) critical update flag related to the first wireless MLD is set to one until a Target Beacon Transmission Time (TBTT) of the first wireless link arrives.

15. The wireless device of claim 14, wherein the first wireless link's newly defined element for the enabling or disabling of the low-capability mode is not announced in a beacon of a second wireless link of the wireless links between the first and second wireless MLDs.

16. The wireless device of claim 14, wherein the first wireless link's newly defined element for the enabling or disabling of the low-capability mode is transmitted in a second wireless link of the wireless links between the first and second wireless MLDs, a number of beacon intervals (BIS) related to the TBTT is defined based on the first wireless link's TBTT and beacon interval.

17. The wireless device of claim 1, wherein the peer device consumes less power in the low-capability state than in the high-capability state.

18. The wireless device of claim 1, wherein the low-capability state comprises a medium listening state, and wherein the high-capability state comprises a frame exchange state.

19. A wireless access point (AP) compatible with an Institute of Electrical and Electronics Engineers (IEEE) 802.11 protocol, the wireless AP comprising:
a controller configured to generate a group-addressed frame that comprises an announcement regarding whether the wireless AP is capable of initiating a peer device's switch from a low-capability state of a low-capability mode to a high-capability state of the low-capability mode; and
a wireless transceiver configured to transmit the group-addressed frame to a wireless non-AP station (STA) associated with the wireless AP.

20. A method for wireless communication, the method comprising:
at a first wireless device, generating an announcement regarding whether the wireless device is capable of initiating a peer device's switch from a low-capability state of a low-capability mode to a high-capability state of the low-capability mode; and
from the first wireless device, transmitting the announcement to a second wireless device.
